(19) United States
(12) Patent Application Publication
(10) Pub. No.: US 2025/0193680 A1
(43) Pub. Date: Jun. 12, 2025

(54) SECURITY DEVICE

(71) Applicant: Renevato Corporation, Tortola VG1110 (VG)

(72) Inventor: Alastair James Nicol Simpson, London (GB)

(21) Appl. No.: 18/726,981

(22) PCT Filed: Jan. 6, 2023
(86) PCT No.: PCT/GB2023/050020

§ 371 Date: Jul. 5, 2024

(30) Foreign Application Priority Data
Jan. 7, 2022 (GB) 2200192.9

(51) Int. Cl. H04W 12/68; H04W 12/06

(52) U.S. Cl. CPC H04W 12/68; H04W 12/068

(57) ABSTRACT

A security device having a memory device and at least one wireless communication module, wherein the memory device includes a physically encoded security code that is derived from biological and/or physiological characteristics of a user of the device.

The present application relates to a security device, and in particular to a personal security device.

### BACKGROUND

A common requirement for individuals is authentication, both on line and off line, to confirm or verify their identity. Commonly, authentication is carried out by an individual to confirm or verify their identity when attempting remote access to goods or services, or to confirm their identity at a location where they are physically present. For example, an individual may be required to input a password or a number, such as a Personal Identification Number (PIN), into a verification device in order for a transaction to be authorized and for the individual to be allowed to access goods and/or services, or in order for the individual to be allowed to enter a physical location, or may be required to input a password or a number into a remote access device, such as a computer browser or App, in order to access their secret data stored online through the remote access device.

One known approach is for an individual to memorize a number of numbers and/or passwords, for use to authorize access to specific goods, services, or data. A problem with this approach is the difficulty most people have in memorizing and accurately reproducing numbers and passwords, so that the memorized numbers and passwords used tend to be relatively short and insecure. Further, people tend to write down numbers and passwords, and these written records are a serious security risk. Another known approach is for an individual to carry a communications device, such as a smartphone, which has codes, such as numbers and/or passwords, stored on it and is arranged to provide these codes to a verification device on request. A problem with this approach is that there is a risk that the communications device may be vulnerable to hacking to illicitly obtain the codes without the knowledge of the individual.

Another issue is that it is often desirable for an individual to share their personal profile or data with selected organizations in order to allow these organizations to provide better and more personalized services and goods to the individual. However, such sharing may allow unintended third parties to access and use the individuals profile and personal data without their authorisation, and possibly without their knowledge. Although, in theory, it should be possible for an individual to control access to their profile and personal data, in practice, this is difficult and onerous to do. One possible approach is for an individual to never share their personal information with anyone, but this will reduce the standard of personalization of the services and goods they receive. As a result, individuals are placed in an unfortunate dilemma.

Accordingly, it is desirable to provide an improved means for an individual to authenticate their identity. Also, it is desirable to provide means for an individual to control their data and to decide who has access to it.

The embodiments described below are not limited to implementations which solve any or all of the problems described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

In a first aspect, the present disclosure provides a security device comprising: a memory device; and one or more wireless communication modules; wherein the memory device comprises a physically encoded security code, the security code being derived from biological and/or physiological characteristics of a user of the device.

In a second aspect, the present disclosure provides a security device comprising: a memory device; one or more wireless communication modules; and one or more mechanical switches linking the memory device to the one or more wireless communication modules; wherein the mechanical switches can be selectively opened or closed by physical manipulation of the security device to place the security device in different operating modes providing different access to the memory device by the plurality of wireless communication modules.

In a third aspect, the present disclosure provides a security device comprising: a memory device; one or more wireless communication modules; and a plurality of sections each comprising a mesh of conductive traces; wherein the plurality of sections can be selectively moved between a first position in which they form a Faraday cage around the one or more wireless communication modules and at least one second position where they do not form a Faraday cage by physical manipulation of the security device.

In a fourth aspect, the present disclosure provides a security device comprising: a memory device; one or more wireless communication modules; and a metal layer surrounding the memory device and the one or more wireless communication modules, wherein the metal layer comprises an ferromagnetic alloy having a permanent magnetic field.

In a fifth aspect, the present disclosure provides a security device comprising: a memory device; and one or more wireless communication modules; wherein the memory device comprises a semiconductor element comprising a pattern of word and bit lines which physically encode the instructions to be followed by the security device in operation.

In a sixth aspect, the present disclosure provides a security device comprising: a memory device; and one or more wireless communication modules; wherein the memory device comprises a semiconductor element comprising a pattern of word and bit lines which physically encode a security code.

In a seventh aspect, the present disclosure provides a method of authenticating a user identity using a security device, the method comprising: providing a security device comprising: a memory device storing a security code associated with a user; and a Near Field Communication (NFC) module; pairing a mobile communications device with the security device; and in response to the mobile communications device receiving a request for authentication of a user identity from a remote server: carrying out a security handshake process between the mobile communication device and the NFC module of the security device to provide security handshake data derived from the security code to the mobile communications device; sending the security handshake data from the mobile communications device to the remote server; the remote server confirming whether the security handshake data received by the remote server is derived from the security code associated with the user; and the remote server authenticating the user identity if the security handshake data received by the remote server is confirmed to be derived from the security code associated with the user.

In an eighth aspect, the present disclosure provides a method of providing a secure handshake by a security device comprising a security code derived from biological and/or physiological characteristics of a user of the device, the method comprising: the security device deriving a handshake from at least a part of the security code; and the security device providing the handshake to a remote device.

The different aspects of the invention may be combined as appropriate.

### BRIEF DESCRIPTION OF THE DRAWINGS

Embodiments of the invention will be described, by way of example, with reference to the following drawings, in which:

FIG. 1 is a schematic diagram illustrating a security device according to a first embodiment;

FIG. 2 is a schematic diagram illustrating further constructional details of the security device of FIG. 1;

FIG. 3 is an illustration of the external appearance of the security device of FIG. 1;

FIG. 4 is a schematic diagram showing different operating modes of the security device of FIG. 1;

FIGS. 5a to 5c are schematic illustrations of different functionalities of the security device of FIG. 1 in an online mode;

FIG. 6 is a schematic illustration of functionality of the security device of FIG. 1 in a data access mode;

FIG. 7 is a schematic illustration of functionality of the security device of FIG. 1 in an update mode; and

FIG. 8 is a schematic illustration of a security device according to a second embodiment.

Common reference numerals are used throughout the figures to indicate similar features.

### DETAILED DESCRIPTION

Embodiments of the present invention are described below by way of example only. These examples represent the best mode of putting the invention into practice that are currently known to the applicant, although they are not the only ways in which this could be achieved. The description sets forth the functions of the example and the sequence of steps for constructing and operating the example. However, the same or equivalent functions and sequences may be accomplished by different examples.

As can be understood from the following detailed description, the present disclosure provides a stand alone and hardy device which will easily fit into a users daily life. The device will be provide a user with a unique password or security code to the on and offline worlds. The device has unique security features which provide the user with the best authentication. The device may literally become the users key to life. The device may enhance user interaction with the physical world to enable better and more informed life choices. The device password/security code and/or handshake can never be stolen or hacked. The device can provide a unique password. If the device is lost it will cease to work. Only the intended user can recover it.

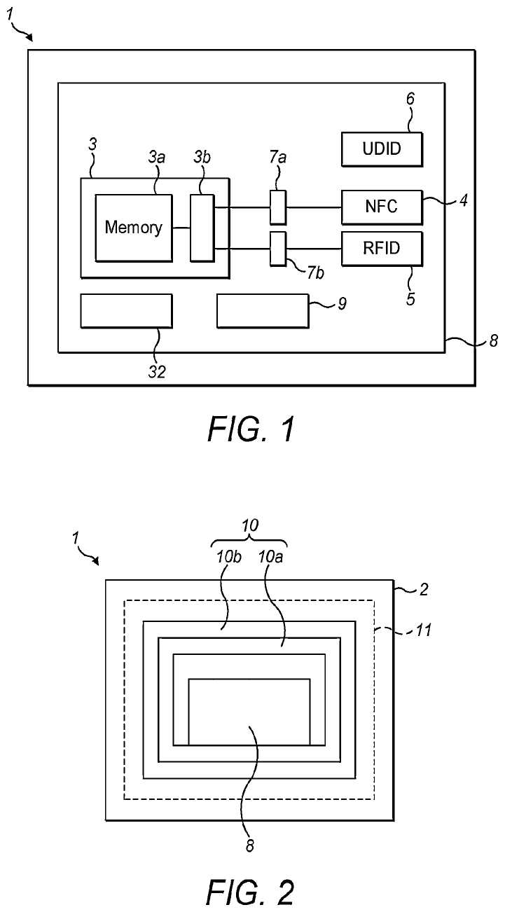

FIG. 1 shows a schematic diagram showing an overview of a security device 1 according to a first embodiment.

In the illustrated first embodiment, the security device 1 comprises a body 2 containing a plurality of electronic components 8. In the illustrated embodiment, the body 2 of the security device 1 is similar in size to a conventional key, such as a door key or a vehicle key, so that the security device 1 can be carried and stored by a user in a similar manner to conventional keys. For example, by being attached to a key ring or key fob of a user together with their conventional keys. This may assist in making the security device 1 convenient to use, and help to prevent accidental loss of the security device. It is anticipated that the carrying of conventional keys will be commonplace for the foreseeable future, making the security device 1 convenient to use.

The electronic components 8 of the security device 1 comprise a memory device 3 and a plurality of wireless communication modules. In the illustrated embodiment, the wireless communication modules comprise a Near Field Communication (NFC) module 4, a Radio Frequency ID (RFID) module 5, and a device identifier (ID) module 6. The NFC module 4 and the RFID module 5 include respective NFC and RFID antennas, and the ID module 6 comprises an NFC antenna. A unique device identifier, or ID, of the security device 1 is stored in the ID module 6. However, this is not essential, and the identifier of the security device 1 may be stored elsewhere on the security device 1. In some examples the device identifier, or ID, may be an International Mobile Equipment Identity (IMEI) code, or similar code. Further, it is not essential that the device identifier is unique, provided that the number of different device identifiers is sufficiently large for the device identifier to be used for authentication, as discussed below. In some examples the NFC module 4 may comprise an NFC chip. In some examples the RFID module 5 may comprise an RFID chip. In some examples the ID module 5 may comprise an ID chip. Further, the electronic components of the security device 1 comprise an energy storage module 9 arranged to provide power to the other components of the security device 1. In some examples the energy storage module 9 may comprise a battery.

Access by the NFC module 4 and the RFID module 5 to the memory device 3, and the data it contains, is controlled by respective switches 7a and 7b. Preferably, the switches 7a and 7b are mechanical or physical switches which can selectively connect or disconnect the NFC module 4 or the RFID module 5 to the memory device 3 as selected by a user of the security device 1 by physical manipulation of the security device 1, as is explained in more detail below.

In the illustrated embodiment, the memory device 3 comprises a memory or data store 3a comprising at least one semiconductor element, which may be a silicon wafer. The silicon wafer comprises a pattern of word and bit lines physically hard-coding data stored in the data store 3a, so that the data stored in the data store 3a is hard-coded and fixed during manufacture of the data store 3a, the memory device 3 and the security device 1, and cannot be subsequently changed during operation of the security device 1. The data store 3a contains the instructions, such as the software, followed by the security device 1 in operation, so that the software executed by the security device 1 is fixed and physically hard-coded into the semiconductor element.

The memory device 3 further comprises a wireless interface 3b selectively connectable to the NFC module 4 and the RFID module 5 by the switches 7a and 7b.

The data store 3a of the memory device 3 also stores a security code, which is a binary code stored in the security device 1 and unique to the user of the security device 1. In the illustrated example, the security code is a multi-million bit binary code, which may be regarded as a multi-million bit secure key. In other examples, the security code may be longer or shorter, as required to provide desired levels of security and functionality in any specific implementation. In general, the security code may be arbitrarily long. In the illustrated example, the security device 1 uses AES 192 bit encryption, so that the stored security code can be utilised to provide a handshake security key having 6.2×10⁵⁷ possible combinations.

The security code is stored in the data store 3a of the memory device 3 by the security code being hard-coded into the at least one semiconductor element, as discussed above, so that the security code is fixed and physically hard-coded into the semiconductor element during manufacture of the data store 3a, the memory device 3 and the security device 1, and cannot be subsequently changed during operation of the security device 1. However, this is not essential, and the security code may be stored in other ways.

The device identifier, or ID, of the security device 1 is stored in the ID module 6 by being hard-coded into a semiconductor element, which may be the same semiconductor element used by the memory device 3. However, this is not essential, and the identifier of the security device 1 may be stored elsewhere on the security device 1.

The security device 1, and in particular the electronic components 8 including the memory device 3, is a non-OS device having no operating system, commonly referred to as a solid state bare metal device. Accordingly, the security device 1 is limited to operating according to the instructions which are physically coded or hard-coded into the semiconductor element of the memory device 3, and cannot have these instructions changed by external inputs after manufacture. Accordingly, the security device 1 is inherently “unhackable” by virtue of its physical construction, so providing improved security.

In the illustrated example, the instructions followed by the security device 1 in operation and the security code are both stored in the same data store 3a. This is not essential, and in other examples these may be stored in separate data stores.

In the illustrated example, the physically coded or hard-coded data is stored as word and bit lines in at least one silicon wafer. This is not essential, and other forms of physically coded or hard-coded data storage may be used in other examples. In some examples, bare metal coding may be used.

The security code stored in the memory device 3 of the security device may be generated in any suitable manner. In some examples the security code may be a randomly generated code, such as a randomly generated bit string. Many methods of generating random codes and checking that they are suitable for use as security codes are known, and any suitable method may be used. In some examples, instead of being randomly generated the security code may be derived from characteristics of the user themselves, such as biological and/or physiological characteristics of the user.

In some examples where the security code is derived from characteristics of the user, the security code may be derived from biometric data of the user. In some examples this biometric data may be iris pattern data derived from scans of one iris or both irises of the user. It will be understood that in such examples the security code is a bit string derived from iris pattern data, and is not an image or photograph of the iris scan.

In some other examples where the security code is derived from characteristics of the

user, the security code may be derived from DNA data of the user. In some examples this DNA data may be derived from a genetic sequencing of the users DNA.

In the illustrated examples the security code is derived from biological or physiological characteristics of the user, such as biometric data. The security code is generated by carrying out a number of translation and encoding processes on the biological or physiological characteristic data or biometric data, such as an iris scan. The security code is preferably derived from the biological or physiological characteristic data, or biometric data, of the user, in a suitable and not publicly known manner so that third parties cannot reproduce the security code from any user characteristic data they possess. Further, the security code is preferably derived from the biological or physiological characteristic data, or biometric data, of the user, in a non-reversible manner so that third parties cannot reproduce the user characteristic data from the security code.

Without wishing to be bound by theory, it is expected that using the raw user characteristic data itself as the security code could potentially allow third parties to reproduce the security code from user characteristic data gathered from the user clandestinely or under some pretext, or to derive user characteristics from a fully or partially known security code. These potential issues are overcome by deriving the security code from the biometric, or other, user characteristic data in a suitable and not publicly known non-reversible manner.

In the illustrated examples the security code is derived from biological or physiological characteristics of the user in a non-deterministic manner, that is, in a manner based on at least in part on random or pseudo-random input. This may provide further assurance that third parties cannot reproduce the security code from any user characteristic data they possess. Further, so this may ensure that security codes for the same user which are derived from the same biological or physiological characteristics of the user on different occasions will be different. In the event that the security device 1 is lost or stolen and a new security device 1 is issued to the user, this will ensure that even if a third party obtains the lost or stolen security device 1 and attempts to use it the security code will not match the security code of the newly issued security device 1.

In examples where the security code is derived from the biological and/or physiological characteristics of the user, the user may be regarded as being or providing their own security code.

FIG. 2 is a schematic diagram showing the physical structure of the security device 1 in more detail.

The body 2 of the security device 1 comprises a dual metal layer 10, which completely surrounds the electronic components 8, including the memory device 3, so that the electronic components 8 including the memory device 3, are encased in the dual metal layer 10. The dual metal layer 10 comprises an inner metal layer 10a comprising a ferromagnetic metal alloy having a permanent magnetic signature and an outer metal layer 10b. This structure of a dual metal layer 10 surrounding the electronic components 8 prevents physical access to the electronic components, and in particular to the memory device 3, even by third parties having the security device 1 in their possession. This provides improved security for the security code stored in the memory device 3. In some examples, the memory device 3 may be further protected by hardware security measures to protect the memory device 3 from physical access. For example, the dual metal layer 10 may include embedded wires, and the memory device 3 may be arranged to disable, destroy, or wipe itself, if these embedded wires are broken. In the illustrated example the inner metal layer 10a and the outer metal layer 10b of the dual metal layer 10 comprise nickel alloys.

The body 2 of the security device 1 further comprises a layer 11 of conductive metal wires or traces enclosing the dual metal layer 10, and arranged to form a Faraday cage around the dual metal layer 10 and the encased electronic components 8. The wires or traces forming the Faraday cage are arranged to provide shielding against electromagnetic signals, at least at the frequencies useable by the NFC module 4, the RFID module 5, and the ID module 6. In the illustrated example, the layer 11 comprises copper wires arranged to form a copper mesh cage. In the illustrated example the layer 11 comprises multiple sections arranged for relative movement to allow the Faraday cage to be selectively opened and closed, as will be discussed in more detail below.

In the illustrated embodiment, the inner layer 10a of the dual metal layer 10 comprises a nickel alloy. This nickel alloy comprises nickel and small amounts of other elements. Nickel is a ferromagnetic material, and the total amounts of the other elements in the nickel alloy are selected such that the nickel alloy of the inner layer 10a of the dual metal layer 10 is also a ferromagnetic material. The ferromagnetic properties of the nickel alloy of the inner layer 10a allows the metal layer 10 to be permanently magnetised during the manufacture of the security device 1. The resulting permanent magnetism of the inner layer 10a will have a magnetic signature which depends upon the identities and amounts of the other elements (that is, elements other than nickel) making up the nickel alloy of the inner layer 10a. This magnetic signature may be used as a magnetic signature of the security device 1.

In the illustrated embodiment, the outer layer 10b of the dual metal layer 10 comprises nickel, and surrounds the inner layer 10a. Although nickel is a ferromagnetic material, the outer layer 10b is not permanently magnetised. The nickel outer layer 10b will not prevent the magnetic signature of the nickel alloy of the inner layer 10a being sensed and identified. However, in practice, it may be necessary to limit the thickness of the outer layer 10b so that the magnetic signature of the nickel alloy of the inner layer 10a can be readily identified.

In practice, there are a relatively large number of nickel alloys having uniquely distinguishable magnetic signatures. The applicant has determined that there are at least 23 distinct base nickel alloys having ferromagnetic properties and distinct magnetic signatures, and at least 52 compounds which can be added in small amounts to these base nickel alloys to modify their magnetic signatures, so that different nickel alloys having at least about 3500 different magnetic signatures can be produced and uniquely distinguished by their magnetic signature. Typically, the added amount of the compounds is no more than about 2%.

Accordingly, at least 3500 different nickel alloys can be produced and uniquely distinguished by their respective magnetic signatures. Although this number is not sufficient to allow each security device 1 to have a unique magnetic signature, it is sufficient to allow the magnetic signatures of different security devices 1 to be used as a verification that the security device 1 is authentic, and to encode user related information in useful ways, as will be discussed in more detail below.

In some examples, the device identifier stored in the ID module 6 may correspond to the magnetic signature of the security device 1. In such examples, the device identifier will not be unique, but the number of different device identifiers will still be sufficient to allow authentication, as explained above regarding the magnetic signature.

In the illustrated embodiment, the inner layer 10a comprises a nickel alloy. In other examples, the inner layer 10a may alternatively comprise alloys of other ferromagnetic metals, such as an iron alloy, a cobalt alloy, or a rhodium alloy. However, without wishing to be bound by theory, it is expected that a nickel alloy will generally be preferable to these alternative alloys, which may suffer from problems of poor environmental stability and vulnerability to corrosion, or high cost. In other examples, the inner layer 10a may alternatively comprise some other non-ferromagnetic material or materials. However, in such examples the inner layer 10a will not exhibit a permanent magnetic signature as discussed above. In the illustrated embodiment, the outer layer 10b comprises nickel. In other examples, the outer layer 10b may alternatively comprise other metals.

When a security device 1 is issued to a user, the organization issuing the security device 1 also establishes a secure online user account associated with the security device 1. This secure online account may be accessed by the user by using a user smartphone, or other suitable device. The secure online account is secured by requiring user authentication to enable access to the secure online account. In the illustrated embodiment this user authentication is a user PIN, but other authentication methods may additionally or alternatively be used in other examples. Many such authentication methods are known, and need not be described in detail herein. In the illustrated embodiment, the user does not require the security device 1 in order to access the secure online user account. However, in some examples, the user could be required to use the security device 1 for authentication in order to access some functions of the secure online user account.

As will be discussed in more detail below, the user may use the secure online account to update some user information stored on the security device 1. However, the secure online account does not allow the security code to be changed or accessed, or allow the instructions followed by the memory device 1, such as the instructions stored in the memory device 3, to be changed. As is explained above, such changes are impossible in the illustrated embodiment, where the security code and instructions are hard-coded.

As will be discussed in more detail below, the user may use the secure online account to activate or initiate a new security device 1, or to cancel an existing security device 1.

The user may use the secure online account to report that the security device 1 has been lost or stolen. The organization issuing the security device 1 will respond appropriately. For example, by cancelling the security device 1, and possibly by arranging to remotely wipe and/or disable the security device 1 if it is subsequently attempted to use it.

In the illustrated embodiment, the security device 1 is arranged to be placed in one of five possible operating modes by physical manipulation of the security device 1. The five possible operating modes are a locked mode, an offline mode, an online mode, a data access mode, and an update mode. These different modes will be described in more detail below.

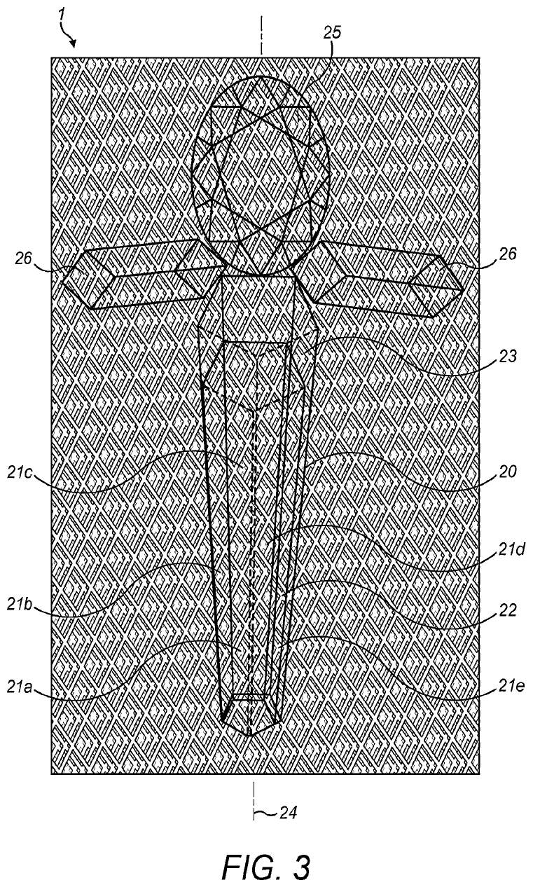

FIG. 3 shows the external appearance of the security device 1.

The security device 1 comprises an elongate member 20 having a pentagonal cross section and five substantially planar faces 21a-e arranged symmetrically about an axis 24. The elongate member 20 comprises a lower body section 22 having a pentagonal cross section and five substantially planar faces 22a-e, and an upper head section 23 having a pentagonal cross section and five substantially planar faces 23a-e. The head section 23 is arranged for rotation relative to the body section 22 about the axis 24. The security device 1 further comprises a looped section 25 extending from the head section 23 along the axis 24 away from the body section 22, and a pair of co-linear arms 26 extending laterally from the head section 23 in respective opposite directions substantially perpendicular to the axis 24. In the illustrated embodiment, the security device 1 is arranged in a stylised ankh shape. Conveniently, the looped section 25 may be used to attach the security device 1 to a key ring, key chain, key fob, or the like, in a conventional manner.

In use, the security device 1 can be set by a user to a desired one of the different operating modes identified above by the user rotating the head section 23 to a specific corresponding rotational position relative to the body section 22. Conveniently, this can be done by the user grasping the body section 22 with one hand, and grasping the looped section 25 and/or the arms 26 extending from the head section 23 with another hand.

The security device 1 comprises a number of switches which are selectively opened or closed at different relative rotational positions of the body section 22 and the head section 23. These switches include, for example, the switches 7a and 7b discussed above, which control access to the memory device 3 by the NFC module 4 and the RFID module 5. Further, different ones of the multiple sections of the layer 11 are arranged to move together with the body section 22 and the head section 23, so that they form a Faraday cage which is selectively opened and closed at different relative rotational positions of the body section 22 and the head section 23. Further, different parts of the dual metal layer 10 may also be selectively opened and closed at different relative rotational positions of the body section 22 and the head section 23. The different combinations of opened and closed switches, the opened or closed Faraday cage, and the opening and closing of the dual metal layer 10, are arranged to set the security device 1 into specific different ones of the different operating modes identified above at corresponding different ones of the five relative rotational positions of the body section 22 and the head section 23 centred on positions where the respective planar faces 22a-e of the body section 22 and the planar faces 23a-e of the head section 23 are substantially aligned.

In order to enable a user to clearly identify which operating mode the security device 1 is currently in, the body section 22 and the head section 23 bear human readable indica and/or symbols which indicate the relative rotational positions of the body section 22 and the head section 23. In the illustrated example, one of the planar surfaces 23a of the head section 23 bears a datum mark, and each of the planar surfaces 22a-e of the body section 22 bears a symbol indicating the respective operating mode of the security device 1 when the planar surface 23a of the head section 23 is substantially aligned with that planar surface 22a-e of the body section 22.

In some examples, the security device 1 may comprise a detent mechanism (not shown) providing tactile feedback to indicate to a user when the relative rotational positions of the body section 22 and the head section 23 bring the planar surfaces 22a-e and the planar surfaces 23a-e into alignment. This may assist the user in correctly setting the operating mode of the security device 1. In some examples, the detent mechanism may act to resist relative rotational movement of the body section 22 and the head section 23 away from an aligned position, so that a predetermined amount of force must be applied by a user in order to change the operating mode of the security device 1. This may assist in preventing unintended changes in the operating mode in use, for example when the security device 1 is located in a pocket and is jostled by other objects, or unintentionally touched by a user.

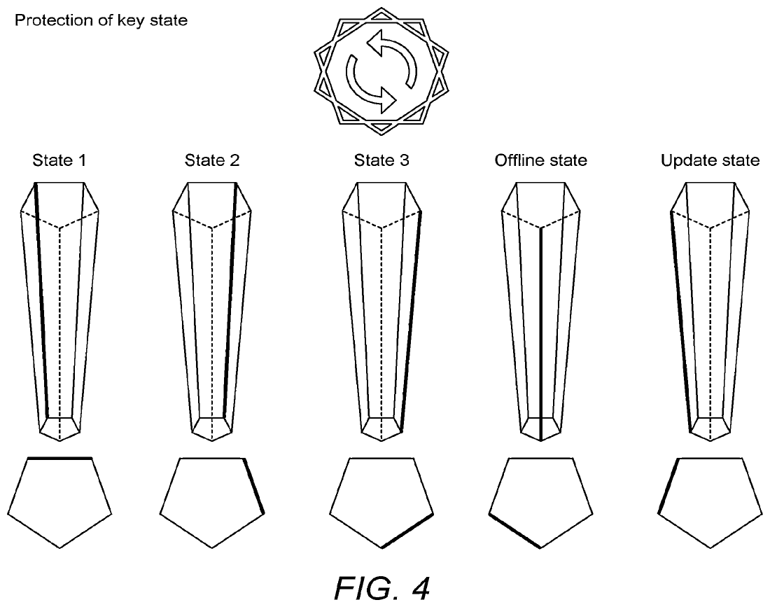

FIG. 4 is a schematic diagram illustrating the different operating modes of the security device 1.

In a first, locked, mode of the security device 1, the layer 11 is arranged by the relative rotational positions of the body section 22 and the head section 23 to form a closed Faraday cage, preventing wireless access to and from the security device 1, and in particular preventing wireless access to and from the NFC module 4, the RFID module 5, and the ID module 6, through their respective antennas. Further, the relative rotational positions of the body section 22 and the head section 23 cause all of the physical switches 7a to 7c to be open, preventing access to the memory device 3 by the NFC module 4, the RFID module 5, and the ID module 6. In this locked mode, the security device cannot be communicated with, and cannot itself communicate. In some examples, the relative rotational positions of the body section 22 and the head section 23 also cause moveable parts of the dual metal layer 10 to be closed together, to further prevent wireless access to and from the security device 1, and in particular preventing wireless access to and from the NFC module 4, the RFID module 5, and the ID module 6, through their respective antennas.

When the security device 1 is in the locked mode. The security device 1 does not communicate in any way, and in particular does not communicate using NFC or RFID, so that the location and presence of the security device cannot be tracked or identified. Further, the security of the security code stored in the security device 1 is absolute, since no external access to the security device 1 is possible.

In a second, offline, mode, the security device 1 can perform various functions to interact with the physical world, such as vibration. The necessary energy to perform these interaction functions, such as vibrating, may be provided by the energy storage module 9. It will be understood that in addition to the components in the illustrated embodiments, the security device 1 will need to comprise the necessary components to provide the desired interaction functionality. For example, optionally, in examples where the security device 1 is to vibrate, the security device 1 should comprise an electro-mechanical transducer 32.

In a third, online, mode, of the security device 1, the layer 11 is arranged by the relative rotational positions of the body section 22 and the head section 23 to open the Faraday cage to enable wireless access to and from the security device 1, and in particular to enable wireless access to and from the NFC module 4, the RFID module 5, and the ID module 6, through their respective antennas. Further, the relative rotational positions of the body section 22 and the head section 23 cause the physical switches 7a and 7b to be closed, enabling access to the memory device 3 by the NFC module 4 and the RFID module 5. In some examples, the relative rotational positions of the body section 22 and the head section 23 also cause moveable parts of the dual metal layer 10 to be separated or opened, to enable wireless access to and from the security device 1, and in particular to enable wireless access to and from the NFC module 4, the RFID module 5, and the ID module 6, through their respective antennas.

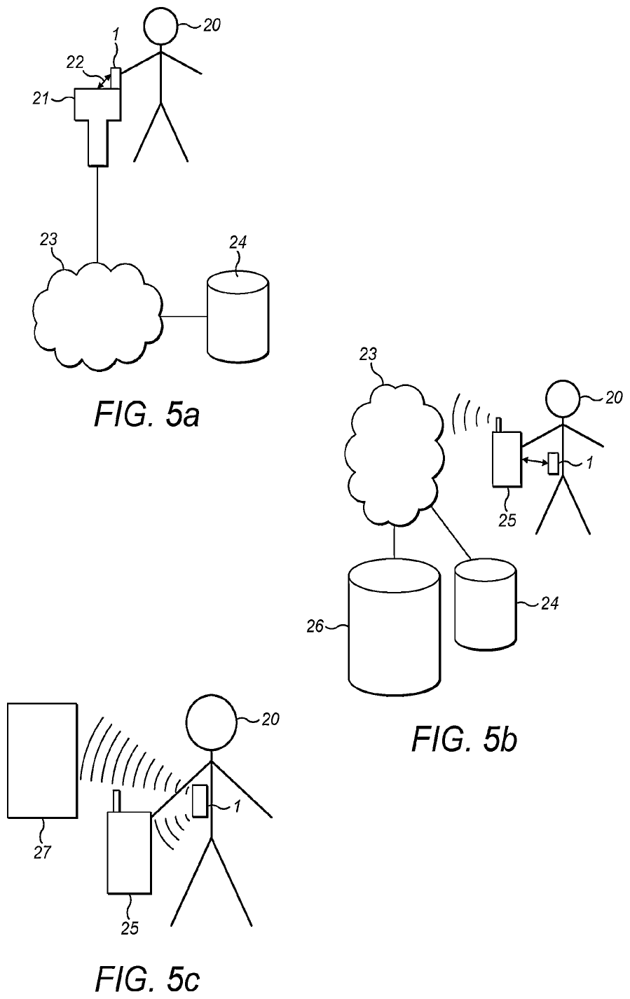

FIGS. 5a to 5c are schematic diagrams illustrating possible functionalities of the security device 1 in the online mode.

One functionality which may be provided by the security device 1 in the online mode is verification of transactions carried out by the user in person. This functionality is illustrated in FIG. 5a.

As shown in FIG. 5a, a user 20 carrying out a transaction, for example an in person purchase, can present their security device 1 to an NFC capable reader terminal 21. The reader terminal 21 and the security device 1 can then communicate using NFC, through the NFC module 4 of the security device. The security device 1 can authenticate the user 20, and so authorise the transaction, by carrying out a security handshake process based on the security code stored by the security device 1 using a 192-bit encryption process. The security device 1 carries out the handshake process with the reader terminal 21 using the NFC module 4 of the security device 1. In some examples, the security handshake process may follow a Transport Layer Security (TLS) handshake protocol. Further, the security device 1 provides the reader terminal 21 with the identity of the security device 1 using the ID module 6 of the security device 1. The reader terminal 21 sends the received security handshake data and identity of the security device 1 to a verification server 24 through a communications network 23, such as the Internet. The verification server 24 confirms whether the security handshake data is authentically derived from the security code of the identified security device 1, and sends a result indicating whether the security handshake data is authentic or not back to the terminal 21 through the communications network 23. The terminal 21 can then allow the transaction if the security handshake is confirmed to be authentic, and can refuse the transaction if the security handshake is not confirmed to be authentic.

As is discussed above, in some examples the security code stored by the security device 1 may be derived from biological and/or physiological characteristics of the user. In such examples the handshake based on the security code will accordingly be derived from the biological and/or physiological characteristics of the user, so that the user may be regarded as “providing their own handshake”.

The verification server 24 may, for example, be operated by, or affiliated with, an issuer of the security device 1, which issuer will have a stored copy of the security code of the security device 1.

In some examples, the terminal 21 may also comprise one or more magnetic sensor(s) able to measure the magnetic signature of the security device 1 when the security device 1 is presented to the terminal 21. In such examples the measured magnetic signature may also be sent to the verification server 24 as a further authentication check. In such examples, the verification server 24 may have the security codes of different security devices 1 stored in association with the magnetic signatures and identities of the different security devices 1. The verification server 24 confirms whether the measured magnetic signature corresponds to the security device 1 identity indicated by the security handshake data, and sends a result indicating whether the security device 1 is authentic or not back to the terminal 21 through the communications network 23 based on whether or not the measured magnetic signature corresponds. The terminal 21 can then allow the transaction if the security device 1 is confirmed to be authentic, and can refuse the transaction if the security device 1 is not confirmed to be authentic.

In FIG. 5a, the security device 1 is shown as being placed in close proximity to the terminal 21 by the user 20. This may not be necessary in order to carry out NFC communication between the terminal 21 and the security device 1. Depending upon the precise form of NFC communication used it may be possible for the authentication by NFC communication to be carried out at a short distance, with the security device 1 simply being carried by the user 20, for example in a pocket. However, without wishing to be bound by theory, it is expected that it will be necessary to place the security device 1 in close proximity to the terminal 21 in order for the magnetic signature of the security device 1 to be measured.

The functionality of FIG. 5a is described in the context of an in person purchase. It will be understood that this is by way of example only, and that this functionality can be used for any type of in person transaction, such as access to a secured building or vehicle, identity verification, to authorise the provision of services, and the like.

Another functionality which may be provided by the security device 1 in the online mode is verification of transactions carried out by the user remotely, such as on-line. This functionality is illustrated in FIG. 5b.

A user can pair their security device 1 with a user mobile device, such a user smartphone. The paired devices can then communicate securely, and verify their identities to one another, using NFC communication. Such pairing of devices is well known, and does not need to be described in detail herein.

As shown in FIG. 5b, a user 20 who has previously paired a user smartphone 25 with a user security device 1 is carrying out an on line remote transaction, for example a purchase from a remote website associated with a transaction server 26, using their smartphone 25. When the transaction server 26 requests authentication from the smartphone 25, the smartphone 25 can communicate with the paired security device 1 using NFC, through the NFC module 4 of the security device 1 to request a corresponding authentication. The security device 1 can then carry out a security handshake process with the smartphone 25 based on the security code stored by the security device 1 using a 192-bit encryption process. The smartphone 25 sends the received security handshake data and identity of the security device 1 to the transaction server 26 through a communications network 23, such as the Internet. The transaction server 26, in turn, sends the received security handshake data to a verification server 24 through the communications network 23. The verification server 24 confirms whether the security handshake data is authentically derived from the security code of the identified security device 1, and sends a result indicating whether the security handshake data is authentic or not back to the transaction server 26 through the communications network 23. The transaction server 26 can then allow the transaction if the security handshake is confirmed to be authentic, and can refuse the transaction if the security handshake is not confirmed to be authentic, and will inform the user smartphone 25 accordingly.

As is discussed above, the verification server 24 may, for example, be operated by, or affiliated with, an issuer of the security device 1, which issuer will have a stored copy of the security code of the security device 1.

In some examples, the verification server 24 may have the security codes of different security devices 1 stored in association with the identities of the user trusted communication devices paired with the different security devices 1 in addition to, or alternatively to, the identities of the different security devices 1. In such examples, the smartphone 25 may send the identity of the smartphone 25 to the transaction server 26 instead of the identity of the security device 1.

In the illustrated embodiment the user communication device is a smartphone. This is by way of example only and other suitable devices may be used, such as a laptop computer, tablet, personal digital assistant (PDA) or a desktop PC.

The functionality of FIG. 5b is described in the context of an on line purchase. It will be understood that this is by way of example only, and that this functionality can be used for any type of remote transaction, such as access to a secured building or vehicle, identity verification, to authorise the provision of services, such as online entertainment or commercial services, and the like.

In some examples, the functionality of FIG. 5b can be extended to further verify the identity of the user by the transaction server 26 also requesting a user PIN, for example a 3 digit PIN. This user PIN may be stored in the verification server 24. The user can input the user PIN into the smartphone 25, and the smartphone 25 sends the user PIN to the transaction server 26 together with the received security handshake data and identity of the security device 1 through the communications network 23. The transaction server 26, in turn, sends the user PIN and the received security handshake data to a verification server 24 through the communications network 23. The verification server 24 confirms whether the user PIN is correct and whether the security handshake data is authentically derived from the security code of the identified security device 1, and sends a result indicating whether this is the case or not back to the transaction server 26 through the communications network 23. The transaction server 26 can then allow the transaction if the user PIN is confirmed to be correct and the security handshake is confirmed to be authentic, and can refuse the transaction if this is not the case, and will inform the user smartphone 25 accordingly.

The verification of user identity provided by the security device 1 in the online mode may, for example, be used to control access to functions of the paired smartphone 25, or other devices, such as access to browsers, Apps, or communications/messaging, such as SMS.

In some examples, the functionality of FIG. 5b can be extended to verify the location of the user. This may be desirable to authorise transactions, such as the provision of goods or services, which may only be carried out for users at specific locations, for example, for practical, legal, or contractual reasons. Alternatively, or additionally, this may be used to provide a further verification of the identity of the user. A user could, for example, specify that transactions, or transactions of particular types, can only be verified by the user from specific predetermined locations, or the verification server 24 may not confirm the user PIN and/or handshake data as correct if they come from a location where the presence of the user is implausible or unlikely.

In some examples, the location of the user may be verified by the security device 1 receiving geolocation data, such as GPS location data, from the paired user smartphone 25, and stripping the header query code of an activation message from the user smartphone 25 to identify the GPS location contained within the IOS and android framework. This GPS location can then be sent to the transaction server 26 together with the other information discussed above and used to verify the location of the user in addition to verifying the identity of the user. In other examples, different forms of geolocation data may be obtained from the paired user smartphone 25 by the security device 1, such as identification data of cell towers or base stations in communication with the smartphone 25.

In some examples, an RFID beacon may be provided which transmits a code which changes over time, or is arranged to interact with a security device 1, for example by conducting a handshake over RFID with the security device 1, to securely provide the security device 1 with a code which identifies the RFID beacon and changes over time. In such examples, the location of the user may be verified by the security device 1 obtaining the code which changes over time from the RFID beacon and sending this code to the transaction server 26 together with the other information discussed above in order to verify the identity of the user. The code can then be used to verify that the user was located within range of the RFID beacon at the time the user identity was verified by comparing the code to the codes transmitted by the RFID beacon at different times and confirming that the code corresponds to the code transmitted by the RFID beacon at the time the user identity was verified. In such examples the security device 1 may obtain the code repeatedly at different times, for example periodically, during a transaction or series of transactions, to provide ongoing verification of the location of the user. In such examples, the RFID beacon should be associated with the transaction server 26 or the verification server 24 so that the transaction server 26 can have confidence that the provided code verifies the location of the user.

Another functionality which may be provided by the security device 1 in the online mode is providing information about the user to nearby third parties. This information may facilitate the provision of bespoke goods and services. This functionality is illustrated in FIG. 5c.

As shown in FIG. 5c, a user 20 is carrying their security device 1 in a store or other retail environment. As the user 20 moves around the store, the user security device 1 receives interrogation signals regarding types of products available in the store from a store RFID device 27. The interrogation signals are received by the RFID module 5 of the security device 1.

In this example, the memory device 3 of the security device 1 contains, in addition to the security code, information regarding user preferences, in this case, user dietary requirements of the user. The RFID module 5 obtains the information regarding the user dietary requirements from the memory device 3, and sends this information by RFID to the store RFID device 27. The store RFID device 27 analyses the received information, and based upon this analysis, sends personalized information regarding products likely to be of interest to the user, and any available offers relating to these products, back to the security device 1 by RFID to the RFID module 5. In some examples, the store may use the provided user dietary requirements to prepare personalized products containing additives or supplements specifically tailored to the users requirements.

The security device 1 then sends the received information regarding the products and offers to the paired user smartphone 23 by NFC, using the NFC module 4, for display to the user.

In the illustrated embodiment the user communication device is a smartphone. This is by way of example only and other suitable devices may be used, such as a laptop computer, tablet, personal digital assistant (PDA) or a desktop PC.

In the illustrated embodiment the store RFID device 27 sends information regarding the products and offers to the security device 1, which forwards this information to the smartphone 25 for display to the user 20. In other examples, the security device 1 may send contact details of the smartphone 25 to the store RFID device 27, and the store RFID device 27 may send the information directly to the user smartphone 25.

Accordingly, as can be understood from the above, the present disclosure provides a portable solid state security device, or key, with a single unique password, which can be used to provide totally secure third-factor authentication. The security device is completely under the control of the user. This may prevent identity theft. Further, the solid state security device is inherently immune to malware.

The functionality of FIG. 5c is described in the context of providing personalised information to a user regarding available products and offers. It will be understood that this is by way of example only, and that this functionality can be used for other types of personalization, such as providing information to the store regarding details of dietary supplements required to be added to products purchased or ordered by the user.

In a fourth, data access, mode, the security device 1 may enable remote user access to a secure store of user data, such as a user data vault. In the fourth, data access, mode, of the security device 1, the layer 11 is arranged by the relative rotational positions of the body section 22 and the head section 23 to open the Faraday cage to enable wireless access to and from the security device 1, and in particular to enable wireless access to and from the NFC module 4, through its antenna. Further, the relative rotational positions of the body section 22 and the head section 23 cause the physical switch 7a to be closed, enabling access to the memory device 3 by the NFC module 4, and also cause the physical switch 7b to be open, preventing access to the memory device 3 by the RFID module 5. In some examples, the relative rotational positions of the body section 22 and the head section 23 also cause moveable parts of the dual metal layer 10 to be separated or opened, to enable wireless access to and from the security device 1, and in particular to enable wireless access to and from the NFC module 4 through the respective antenna.

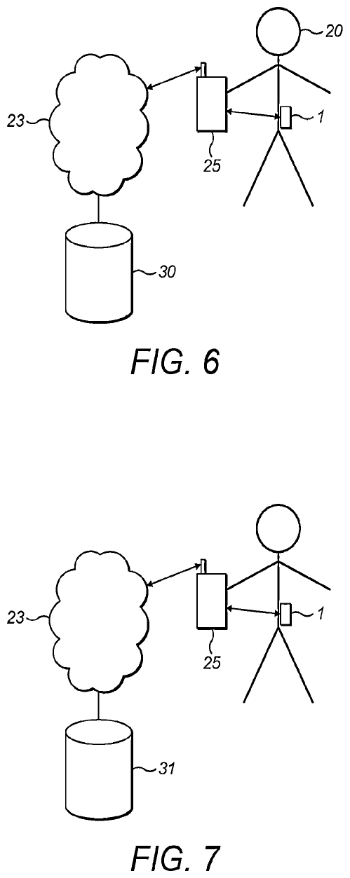

FIG. 6 is a schematic diagram illustrating possible functionality of the security device 1 in the data access mode.

As shown in FIG. 6, the issuer of the security device 1, or a related organization, maintains a secure store 30 of user data. The secure store 30 may be regarded as a data vault or data depository. As described previously, the user 20 has previously paired the user smartphone 25 with the user security device 1.

The user data held in the secure store may comprise financial and/or medical information regarding the user. For example, the user data may include the results of genetic tests on the user and/or user dietary requirements based on the results of the genetic tests. It will be understood that such information may be highly personal and sensitive, while at the same time the user may wish to access the information, or disclose it to others, under some circumstances, such as to medical personnel.

When the user 20 wishes to access their data held in the secure store 30, for example to update a copy of the data stored on the security device 1, the user requests access to the data remotely using the user smartphone 25 through a communications network 23, such as the Internet. This may be done, for example, using a secure dedicated App on the smartphone 25, such as the secure online user account discussed above. The secure store 30 responds by requesting an access PIN, for example a 3 digit PIN, and security handshake data from the security device 1.

The user smartphone 25 then communicates with the paired security device 1 using NFC, through the NFC module 4 of the security device 1, to request security handshake data. The security device 1 then carries out a security handshake process with the smartphone 25 based on the security code stored by the security device 1 using a 192-bit encryption process, and provides the identity of the security device 1 to the smartphone 25 through the ID module 6. The smartphone 25 sends the received security handshake data and identity of the security device 1 to the secure store 30 through the communications network 23, together with an access PIN input by the user into the smartphone 25. The secure store 30 confirms whether the security handshake data is authentically derived from the security code of the identified security device 1, that the identified security device 1 is associated with the same user as the data in the secure data store 30 to which access has been requested, and that the access PIN is correct. If all of these are confirmed, the secure store 30 provides sends an encrypted version of the requested stored user data to the security device 1 through the user smartphone 25. If these are not all confirmed, the secure store 30 denies access to the requested stored user data.

The user can provide access to the stored user data stored on the security device 1 as desired. For example, the user may instruct the security device 1 to provide information regarding user dietary requirements based on genetic tests to be made available to a store, as discussed above regarding FIG. 5c. This may enable the user to be sent personalized information regarding products likely to be of interest to the user, and any available offers relating to these products, and/or enable the store to prepare personalized products specifically tailored to user requirements.

One possible example of user data stored in the secure data store 30, which may be sent to and stored on the security device 1, is, for example, the results of DNA tests for the purpose of identifying, reporting and interpreting health risks. Such DNA tests may, for example, be carried out by genotyping to detect clinically relevant variants in the genomic DNA of the user from saliva. Another possible example of user data is the results of DNA based genealogy tests. Such tests may look at specific locations of the users genome in order to find or verify ancestral genealogical relationships, or to estimate the ethnic background and/or mixture of the user. Another possible example of user data is the results of food intolerance tests. Such tests may provide a diagnostic tool to identify whether the users body is hypersensitive towards a particular food, which could cause an adverse reaction. Another possible example of user data is the results of an IQ test. Such tests may provide a measure of intellectual abilities and potential. Another possible example of user data is a Myer-Briggs type indicator. Such tests are self-help assessment test which may help a user to gain insights about how they work and learn. Another possible example of user data is vaccination status, such a covid-19 vaccination status. Another possible example of user data is diagnostic imaging data of the user. This data may take various forms, and be produced from various types of machine, depending upon the part of the body being imaged, and the purpose of the imaging. Another possible example of user data is physical examination results of the user.

User data may be added to the secure data store 30 as instructed by the user. Similarly, data in the secure data store 30 may be sent to the security device 1 for storage as instructed by the user. The user may access their secure online user account, and after verification, provide instructions for the handling of user data. In some examples, user data may be added directly to the secure data store by the organization which issued the security device 1, and operates the secure online user account, if the user data is generated by or accessible to that organization. In other example, the user may provide the user data through their secure online user account.

FIG. 7 is a schematic diagram illustrating possible functionality of the security device 1 in the update mode.

In a fifth, update, mode, a newly issued security device 1 can be activated. It should be understood that the newly issued security device 1 already contains the security code, stored in the memory device 3. In the fifth, update, mode, of the security device 1, the layer 11 is arranged by the relative rotational positions of the body section 22 and the head section 23 to open the Faraday cage to enable wireless access to and from the security device 1, and in particular to enable wireless access to and from the ID module 6, through its antenna. Further, the relative rotational positions of the body section 22 and the head section 23 cause the physical switches 7b and 7c to be open, preventing access to the memory device 3 by the NFC module 4 and the RFID module 5. In some examples, the relative rotational positions of the body section 22 and the head section 23 also cause moveable parts of the dual metal layer 10 to be separated or opened, to enable wireless access to and from the security device 1, and in particular to enable wireless access to and from the ID module 6 through its antenna.

As described previously, the user 20 has previously paired the user smartphone 25 with the user security device 1, and has opened a secure online user account. In order to activate the security device 1, the user travels, with the security device 1 and the paired user smartphone 25 to a user selected geolocation. In some examples, the user selected geolocation may be communicated in advance to the organization issuing the security device 1 by the user, or may be mutually agreed in advance between the issuing organization and the user. At the selected geolocation, the user accesses their secure online user account, for example on a secure server 31, using the user smartphone 25, and the user authenticates themselves, for example by entering a user PIN, the security device 1 communicates with the user smartphone 25 by NFC, using the ID module 6, and the user smartphone 25 connects the security device 1 to the secure server 31 to provide the identity of the security device 1 to the secure server 31. The secure server 31 can then verify whether the identity of the security device 1 and the user smartphone 25 are paired and associated with the user. Accordingly, the new security device 1 can only be activated when it is connected to a trusted user communication device 25 with which it is paired. When the security device 1 is activated, the geolocation where the activation was requested is stored by the issuing organization, for example in the secure server 31. This geolocation is then used as a designated geolocation for that security device 1 and user. The geolocation may be stored, for example, by receiving GPS location data from the user smartphone 25, and stripping the header query code of an activation message from the user smartphone 25 to identify the GPS location contained within the IOS and android framework.

In examples where the geolocation is communicated in advance or mutually agreed, the secure server 31 may be arranged to check the location of the new security device 1, for example by requesting GPS-based geolocation information from the user smartphone 25, and may only enable activation when the security device 1 is in this geolocation.

Similarly, in the fifth, update, mode, the user may request deactivation of an existing security device 1. This may be done by the user traveling with the security device 1 and the paired user smartphone 25 to their designated geolocation where the security device 1 was activated. The user can then access their secure online user account, for example on a secure server 31, using the user smartphone 25, and authenticates themselves, for example by entering a user PIN, in a similar manner to that discussed above regarding activation. The user can then request deactivation of the security device 1.

The user may also access their secure online user account using the user smartphone 25, and authenticate themselves, for example by entering a user PIN, and then request the issue of a new, or additional, security device 1, or request the deactivation and possibly remote wiping and/or permanent disabling, of a lost or stolen security device 1. Optionally, to provide improved security, it may be required that the user accesses their secure online account from their designated geolocation.

The different functionality provided by the security device 1 are discussed above with reference to the illustrated embodiment of the security device 1, as shown in FIG. 3. Corresponding functionality may be provided by other designs of the security device 1. Such other designs may, for example, comprise other mechanisms and/or means for a user to place the security device 1 in the different modes.

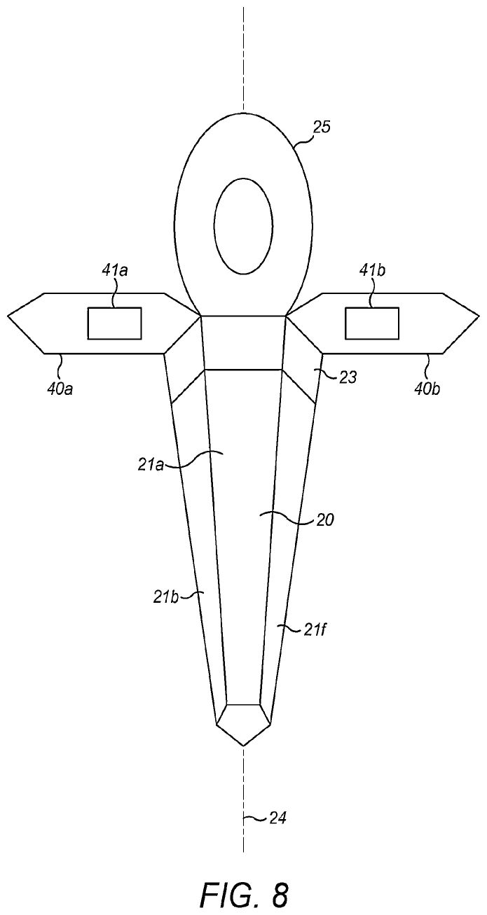

FIG. 8 is a schematic diagram of a security device 1 according to a second embodiment.

The security device 1 of the second embodiment has similar functionality to the security device 1 of the first embodiment. As can be seen in FIG. 8, the security device 1 of the second embodiment is similar in appearance to the security device 1 of the first embodiment.

The security device 1 of the second embodiment comprises an elongate member 20 having a pentagonal cross section and five substantially planar faces 21a-e arranged symmetrically about an axis 24. The elongate member 20 comprises a lower body section 22 having a pentagonal cross section and five substantially planar faces 22a-e, and an upper head section 23 having a pentagonal cross section and five substantially planar faces 23a-e, with the head section 23 arranged for rotation relative to the body section 22 about the axis 24. The security device 1 further comprises a looped section 25 extending from the head section 23 along the axis 24 away from the body section 22.

In the second embodiment, the security device 1 has a pair of detachable arms 40a and 40b, which may be releasably attached to the head section 23 in positions where the arms 40a and 40b are co-linear, and extending laterally from the head section 23 in respective opposite directions substantially perpendicular to the axis 24. In the second embodiment, each of the detachable arms 40a and 40b comprises a respective data store 41a, 41b, and the detachable arms 40a and 40b and the head section 23 are provided with cooperating electrical connections, so that when the detachable arms 40a and 40b are connected to the head section 23 the electronic components 8 of the security device 1 can access data stored in the data stores 41a and 41b.

In the second embodiment, user data may be stored in the data stores 41a and 41b of the detachable arms 40a and 40b. In the second embodiment, when additional or updated user data is added to the secure data store, and it is desired to send this user data to the security device 1, this may be done by sending new detachable arms 40a and/or 40b containing the new user data in their respective data stores 41a and 41b to the user. The user can then attach the new detachable arms 40a and/or 40b in place of the old detachable arms, as necessary. This may be used as an alternative to the updating process of FIG. 6.

In some examples of the second embodiment, only one of the detachable arms 40a and 40b may be used to store the user data. The other one of the detachable arms 40a and 40b may be used for other purposes, for example to store data relating to store loyalty programs, or the like.

Further, in the second embodiment, the user may be provided with a number of additional detachable arms having different functions, and may select which of the available detachable arms to attach to the security device 1 depending on the intended use of the security device 1 and current user requirements.

In some examples, the detachable arms 40a and 40b may be replaced by other detachable elements.

As is described above, the security device 1 may be paired with a trusted user communication device, such as a smartphone. Such pairing may be carried out with any desired number of trusted communication devices, and also with user smart or connected devices such as vehicles or a smart home. Such pairings may be used to enable the user commination devices to issue an alert or warning if contact with the security device 1 is lost. Such warnings may provide the user with an early alert if the security device 1 is lost or stolen. Of course, such warnings may be issued unnecessarily when the user places the security device 1 in the locked operating mode, but it is easy for the user to recognise such warnings as false alarms because they are triggered by user action.

Such pairing of the security device 1 with other user devices can be used to allow the security device 1 to recognise that it has likely been lost or stolen, for example if no user communication devices or locations, such as a vehicle, can be contacted. The security device 1 may respond to this by automatically disabling or wiping itself.

As is explained above, the security device 1 may have a specific magnetic signature, which may be sensed to further authenticate the security device. In some examples, the specific magnetic signature used for a security device 1 may be related to the geographic region in which the security device is manufactured, or the geographic region in which the intended user resides. In some examples, the relationships between geographical areas and magnetic signatures may be changed from time to time.

In some examples the security device 1 may have a specific magnetic field signature corresponding to a health condition or genetic condition of the user.

In some examples, a reader may be arranged to measure the magnetic signature only of the security device 1 to authenticate the security device 1 and user. This may be used in relatively low security applications, or where it is desired to use the security device 1 in a location where the necessary on line access to authenticate the security device 1 in the usual manner is not available. For example, this may be used to release keys from a locked key box for access to rented accommodation in remote locations.

In the illustrated embodiments, the security device is placed in the different operating modes by rotating the body portion and the head portion into different relative positions. In some examples the security device may be further provided with a manually released locking device which prevents relative rotation of the body portion and the head portion and changing the operating mode of the security device unless some additional mechanical input is simultaneously provided, such as pushing a button. This may assist in preventing accidental unintended changes in the operating mode of the security device.

In the illustrated embodiments, the security device is able to operate in a number of different operating modes. In other examples, the security device may have different operating modes available, either in addition to, or in place of, the modes disclosed above. Further, in some examples, some of the operating modes disclosed above may not be available to the security device.

In the illustrated embodiments, the security device comprises an energy storage module, such as a battery. In some examples the security device may comprise an energy harvesting mechanism, such as photo-electric cells, or a vibration energy harvester, to allow the energy storage module to be recharged in operation of the security device.

In the illustrated embodiments, 192-bit encryption is used. In other examples different forms of encryption could be used.

In the illustrated embodiments, GPS is used to determine location. In other examples different satellite navigation systems may be used.

In the illustrated embodiments, mechanical switches are used to selectively connect the RFID module, the NFC module, and the ID module to the memory module. In other examples the mechanical switches may instead selectively connect respective antennas to the RFID module, the NFC module, and the ID module.

In the illustrated embodiments, a dual metal layer is used to encase the electronic

components of the security device. In other examples a non-metal material may be used, in whole or in part. In other examples, the dual metal layer may encase only the memory device. In other examples the dual may layer may be replaced by a different number of metal layers. In some examples, the dual metal layer may be replaced by a single metal layer.

In the illustrated embodiments, the dual metal layer comprises an inner layer of a ferromagnetic nickel alloy surrounded by an outer layer of nickel. In other examples, a ferromagnetic nickel alloy may be used for the outer layer, which ferromagnetic nickel alloy may be the same as, or different from, the ferromagnetic nickel alloy of the inner layer.

In the illustrated embodiments, the NFC and RFID antennas are encased within the dual metal layer. In other examples, some or all of these antennas may be located outside the dual metal layer.

In the illustrated embodiments, the ID module has a dedicated NFC antenna. In other examples that ID module and the NFC module may share a common NFC antenna.

In the illustrated embodiments, the security device comprises a Faraday cage, separate from the dual metal layer. In other examples, wireless access to the security device may be controlled by opening and closing parts of the dual metal layer without any separate Faraday cage being provided.

In the illustrated embodiments, the security device comprises three wireless communication modules. In other examples, the security device may comprise a different number of wireless communication modules. In general, the security device may comprise one or more wireless communication modules.

In the illustrated embodiments, the same organization issues the security device and operates the secure online user account. In other examples, this may be done by different organizations. Suitable methods of secure cooperation between organizations are well known, and do not need to be described herein.

In the illustrated embodiments, the data comprising both the instructions followed by the security device in operation and the security code is stored as hard-coded data. In some other examples, one or both of these may be stored as other forms of data, without being stored as hard-coded data. In such examples, the non-hard-coded data may be protected against copying and/or alteration in any suitable manner. Many data protection methods are known.

In the illustrated embodiments, the device identifier (ID) is stored in the ID module. In some examples the device identifier may be engraved on the exterior of the security device 1.

In the illustrated second embodiment, the security device comprises two detachable arms. In other examples the security device may comprise a different number of detachable arms. In particular, the security device may comprise a single detachable arm.

In the described embodiments of the invention parts of the system may be implemented as a form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of preferred embodiments is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1-77. (canceled)

78. A security device comprising:
a memory device; and
one or more wireless communication modules;
wherein the memory device comprises a physically encoded security code, the security code being derived from biological and/or physiological characteristics of a user of the device.

79. The security device of claim 78, wherein memory device comprises a semiconductor element comprising a pattern of word and bit lines which physically encode the security code.

80. The security device of claim 78, in which the security code is derived from biological and/or physiological characteristics of the user.

81. The security device of claim 78, in which the security code is derived from biometric data of the user.

82. The security device of claim 78, in which the security code is derived from DNA data of the user.

83. A security device comprising:
a memory device;
one or more wireless communication modules; and
one or more mechanical switches linking the memory device to the one or more wireless communication modules;
wherein the mechanical switches can be selectively opened or closed by physical manipulation of the security device to place the security device in different operating modes providing different access to the memory device by the one or more wireless communication modules.

84. The security device of claim 83, in which the one or more wireless communication modules comprise multiple wireless communication modules, and the one or more mechanical switches comprise multiple mechanical switches each linking the memory device to a respective one of the multiple wireless communication modules.

85. The security device of claim 84, in which different ones of the one or more wireless communication modules can access the memory device in the different operating modes.

86. The security device of claim 84, in which the one or more wireless communication modules comprise at least a Near Field Communication (NFC) module and a Radio Frequency ID (RFID) module.

87. The security device of claim 84, in which the one or more wireless communication modules comprise a device identifier (ID) module.

88. The security device of claim 87, in which the ID module stores an identifier of the security device.

89. The security device of claim 83, in which the security device comprises two components arranged for relative rotation and the security device is arranged to be placed in the different operating modes by rotating the two components into respective relative rotational positions.

90. The security device of claim 83, in which the memory device stores a security code.

91. The security device of claim 90, in which the memory device comprises a semiconductor element comprising a pattern of word and bit lines which physically encode the security code.

92. The security device of claim 90, in which the security code is derived from biological and/or physiological characteristics of the user.

93. The security device of claim 90, in which the security code is derived from biometric data of the user.

94. The security device of claim 90, in which the security code is derived from DNA data of the user.

95. The security device of claim 83, and further comprising:
a metal layer surrounding the memory device and the one or more wireless communication modules,
wherein the metal layer comprises an ferromagnetic alloy having a permanent magnetic field.

96. The security device of claim 95, in which the ferromagnetic alloy is a nickel alloy.

97. A security device comprising:
a memory device;
one or more wireless communication modules; and
a plurality of sections each comprising a mesh of conductive traces;
wherein the plurality of sections can be selectively moved between a first position in which they form a Faraday cage around the one or more wireless communication modules and at least one second position where they do not form a Faraday cage by physical manipulation of the security device.
